(19) United States
(12) Patent Application Publication
(10) Pub. No.: US 2009/0302552 A1
(43) Pub. Date: Dec. 10, 2009

(54) Sealing Material

(75) Inventors: Heiko Leinfelder, Nordlingen (DE); Martin Reinthaler, Neusäss (DE); Robert Michels, Thierhaupten (DE); Jurgen Bacher, Wertingen (DE); Martin Christ, Augsburg (DE); Alois Baumann, Rain (DE)

Correspondence Address: LERNER GREENBERG STEMER LLP, P O BOX 2480, HOLLYWOOD, FL, 33022-2480, US

(73) Assignee: SGL CARBON SE, Wiesbaden (DE)

(21) Appl. No.: 12/488,643

(22) Filed: Jun. 22, 2009

Related U.S. Application Data
(63) Continuation of application No. PCT/EP2007/011274, filed on Dec. 20, 2007.

(30) Foreign Application Priority Data
Dec. 22, 2006 (DE) 10 2006 062 330.4

(51) Int. Cl. F16J 15/12

(52) U.S. Cl. 277/608

(57) ABSTRACT

A sealing material is formed as a planar laminate compound made of at least two layers of a graphite film with a maximum density of 1.6 g/cm³ alternating with at least one metal inlay. The metal inlay has a three-dimensional structure and has open depressions on one side which are covered by graphite overlays with a thickness in the range of up to a maximum of 5.0 mm. The depressions are enclosed by elevations intersecting in straight lines, and the ridge lines on both main sides lie approximately on defined planes a, b. Alternatively, the metal inlay has a hole structure both sides of which are covered by graphite overlays with a thickness in the range of up to a maximum of 5.0 mm. The holes are enclosed by webs and on both main sides lie approximately on the planes a, b. The hole area forms 40% to 90% of the total surface area of the metallic inlay.

### CROSS-REFERENCE TO RELATED APPLICATION

This is a continuing application, under 35 U.S.C. § 120, of copending international application No. PCT/EP2007/011274, filed Dec. 20, 2007, which designated the United States; this application also claims the priority, under 35 U.S.C. § 119, of German patent application No. DE 10 2006 062 330.4, filed Dec. 22, 2006; the prior applications are herewith incorporated by reference in their entirety.

### BACKGROUND OF THE INVENTION

### Field of the Invention

The invention relates to a sealing material comprising a sheet-like laminate composed of at least two layers of a graphite foil alternating with at least one metal inlay.

Sealing materials comprising metal inlays and graphite plates or foils produced from expanded graphite by compaction are known in the art (U.S. Pat. No. 3,404,061; German patent application DE-A 25 18 351; U.S. Pat. No. 4,422,894; company brochure TM SIGRAFLEX® from SGL Technologies GmbH). They are used, in particular, for seals, as furnace internals, radiation shields, precipitation plates in electrofilters and for corrosion-resistant linings.

The main reason for the development of such laminates has been the comparatively low loadability of the graphite foils or plates produced by pressing expanded graphite when subjected to tensile and bending forces. During handling in rough, everyday operation, this low strength frequently leads to damage to the unreinforced graphite parts, which would restrict the usability of the products of this type which otherwise display excellent thermal, electrical and chemical properties.

Arrangement and order of the individual layers in such laminates can largely be selected freely and depend on the intended application. In most cases, the graphite is applied to one or both sides of the metal layer.

Depending on the type of adhesion between graphite foil and metal inlay, a distinction can be made between two types of such laminates. In the first case, the adhesion is mechanical. The metal part has surface structures which during pressing of the graphite with the metal part either penetrate into the graphite or are penetrated by the graphite as a result of flow processes.

Examples are punched metal sheets, metal sheets having holes which have not been deburred, woven wire meshes, sintered metals or metal surfaces having porous, rough or damaged surfaces, e.g. surfaces of sealing flanges. Such a frequently undesirable adhesion of the flat seals to the surfaces between which the seal is clamped is described, for example, in German patent publications DE 32 44 595 (col. 2, lines 14-28) and in DE 37 19 484 (col. 1, line 68 to col. 2, lines 1-8). These types of bonds, which are not reproducible and do not occur uniformly over the contacted surfaces, are observed only after prolonged use of surfaces clamped together under sealing conditions and can therefore not be used as a basis for the production of laminates composed of metal and graphite layers.

In the second case, the metal and graphite surfaces are adhesively bonded to one another by means of organic or inorganic adhesives. This method is preferably used when very smooth metal surfaces are present and/or when the surfaces cannot be provided with mechanically acting anchoring elements.

The use of seals composed of graphite foil or laminates containing graphite foil, for example in pipes and apparatuses in the chemical industry and steam lines in power stations and heating plants, is prior art. Graphite foil is resistant to high temperatures and aggressive media, has a relatively low permeability for fluids, has a high compressibility, good springback behavior and a very low tendency to creep under pressure. These properties make graphite foil suitable as sealing material.

The mechanical stability of seals composed of graphite can be increased by embedding reinforcing metal layers (sheet or foil) between two graphite foils. For this reason, laminates composed of a plurality of graphite foils having a thickness of only a few hundred microns (μm) with metal inlays embedded between them are usually used for sealing materials of the prior art at a total thickness of from 1 to 4 mm.

A process for producing laminates composed of a plurality of alternating metal and graphite layers is known from the commonly assigned U.S. Pat. No. 5,509,993 and its counterpart European patent EP 0 616 884. A permanent, adhesive-free bond is produced between the metal and graphite layers by applying a thin layer of a surface-active substance selected from the group consisting of organosilicon compounds, perfluorinated compounds and metal soaps to at least one of the surfaces to be joined and subsequently bringing the surfaces to be joined into contact and bonding them to one another by action of pressure and heat.

Furthermore, German patent DE 10 2004 041 043 B3 and its counterpart U.S. patent application publication US 2006/046025 A1 describe a laminated sealing material comprising at least two layers which are joined to one another and of which at least one first layer is a graphite foil which is bonded to a second layer of graphite foil, fluoropolymer or paper, and a process for producing it. Such a laminate is the to be distinguished by the first and second layers being adhesively bonded to one another by means of a layer of fluoropolymer applied via an aqueous dispersion. This laminate can contain at least one metal reinforcing layer in the form of expanded metal, a punched metal sheet, a perforated metal sheet or braided wire.

For reasons of occupational hygiene and operational safety of plants and environmental protection, especially in connection with the introduction of the German clear air regulations, commonly known as “TA Luft,” newly drafted in 2002, industry has an increasing requirement for sealing materials which make it possible to achieve low leakage rates. Although sealing rings which are composed of a corrugated metal inlay and a graphite foil adhesively bonded onto both sides and meet the abovementioned requirements are also known, for example from the document US 2006/0145428 A1, such sealing means are tied to the size of the prefabricated metal inlay rings.

### SUMMARY OF THE INVENTION

It is accordingly an object of the invention to provide a sealing material for flange connections which overcomes the above-mentioned disadvantages of the heretofore-known devices and methods of this general type and which, as a result of an improved structure compared to the prior art has a leakage rate of less than 105 kPa*l/(s*m) at a clamping pressure of 30 MPa and a differential helium pressure of 1 bar (i.e., meets the requirements of the German standard TA Luft).

With the foregoing and other objects in view there is provided, in accordance with the invention, a sealing material, comprising:

a sheet-like or plate-shaped laminate composed of at least two layers of a graphite foil having a density of not more than 1.6 g/cm³ alternating with at least one metal inlay, the laminate having two main sides;

the metal inlay having a three-dimensional structuring and one-sided open depressions covered by graphite layers having a thickness in a range up to 5.0 mm;

the depressions being enclosed by linearly intersecting raised regions defining ridge lines on the two main sides lying approximately on defined planes a and b.

In accordance with an alternative implementation of the inventive concept there is provided a sealing material, comprising:

a sheet-like or plate-shaped laminate composed of at least two layers of a graphite foil having a density of not more than 1.6 g/cm³ alternating with at least one metal inlay, the laminate having two main sides;

the metal inlay having a perforated structure covered on both sides by graphite layers having a thickness of up to 5.0 mm and having holes enclosed by webs, and wherein the webs on the two main sides lie approximately on defined planes a and b and an area of the holes making up from 40% to 90% of a total area of the metal inlay, and more specifically from 50 to 80% of the total area.

In other words, the objects of the invention are achieved the sealing material as claimed which displays increased pressing of the graphite foils onto the ridge or web lines of the metal inlay and as a result leads to a reduction in leakage. Furthermore, the sealing material of the invention can be cut as required from sheet material and thus allows direct matching to different sealing flange geometries.

In accordance with an added feature of the invention, the metal inlay comprises two structured metal sheets having linearly intersecting raised regions on only one main side with ridge lines lying approximately on a plane and being joined to one another by the respectively other the main side, and wherein the ridge lines and depressions in each case are disposed opposite one another on a rear side thereof.

In accordance with an additional feature of the invention, the ridge lines are formed with a spacing in a range from 1.0 mm to 8.0 mm, more specifically between 2.0 mm and 4.0 mm, and a height of the linear raised regions lies in a range from 0.2 mm to 3.0 mm, more specifically, between 0.5 mm and 1.5 mm. In a preferred embodiment of the invention, the density of the graphite foil is from 0.40 to 1.60 g/cm³.

In accordance with another feature of the invention, the metal inlay embedded between the graphite layers has a thickness of from 20 μm to 2.0 mm, and preferably a thickness of from 0.1 mm to 0.8 mm.

In accordance with a further feature of the invention, the metal inlays embedded between the graphite layers comprise materials selected from the group consisting of stainless steel, steel, iron, aluminum, nickel, copper, titanium, and zinc, and alloys of nickel, copper, aluminum, or zinc.

In accordance with again an added feature of the invention, the metal inlays are joined to the graphite foils by way of a surface-active bonding agent selected from the group consisting of organosilicon compounds, metal soaps, and perfluorinated compounds, or by way of an adhesive.

In accordance with again an additional feature of the invention, the outer layers of graphite foil contain an impregnation of furan resin, phenolic resin, epoxy resin, silicone resin, acrylic resin, or mixtures thereof.

In accordance with a concomitant feature of the invention, a leakage rate of a seal formed by the sealing material, measured in accordance with VDI Guideline 2440, is less than or equal to 10⁻⁵ kPa*1/(s*m).

Other features which are considered as characteristic for the invention are set forth in the appended claims.

Although the invention is illustrated and described herein as embodied in a sealing material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a top perspective view of a first metal inlay 1a placed according to the invention;

FIG. 2 is a bottom perspective view of the metal inlay 1a, as shown in FIG. 1;

FIG. 3 is a cross section taken through the metal inlay 1a, as shown in FIG. 1;

FIG. 4 is a top perspective view of a second metal inlay 1b used according to the invention;

FIG. 5 shows a top perspective view of a third metal inlay 1c used according to the invention.

### DETAILED DESCRIPTION OF THE INVENTION

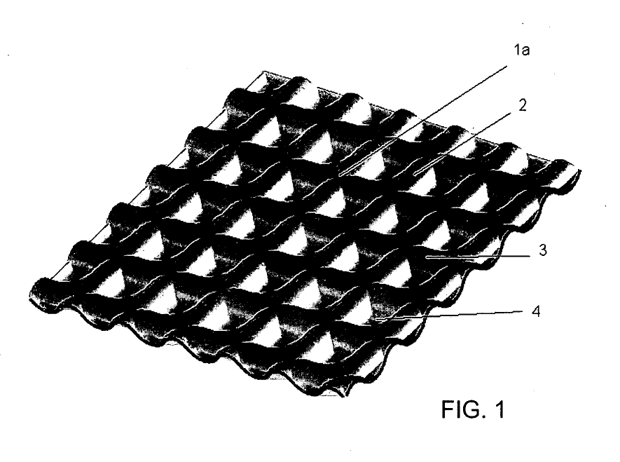

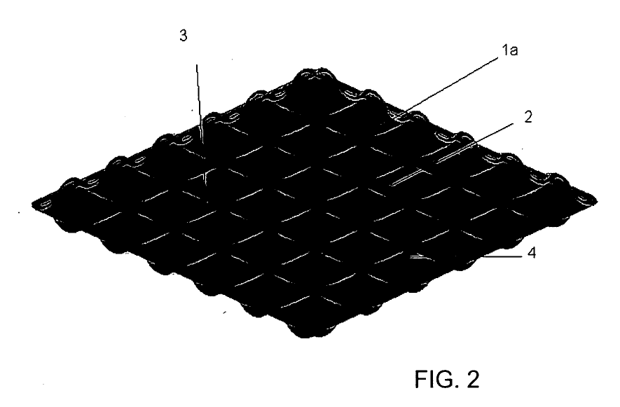

Referring now to the figures of the drawing in detail and first, particularly, to FIGS. 1-3 thereof, there are shown perspective views of a metal inlay 1a used according to the invention, in which the ridge lines of linearly intersecting raised regions 2, 3 on the two main sides lie approximately on the planes a, b. The ridge lines enclose depressions 4 which are open on one side.

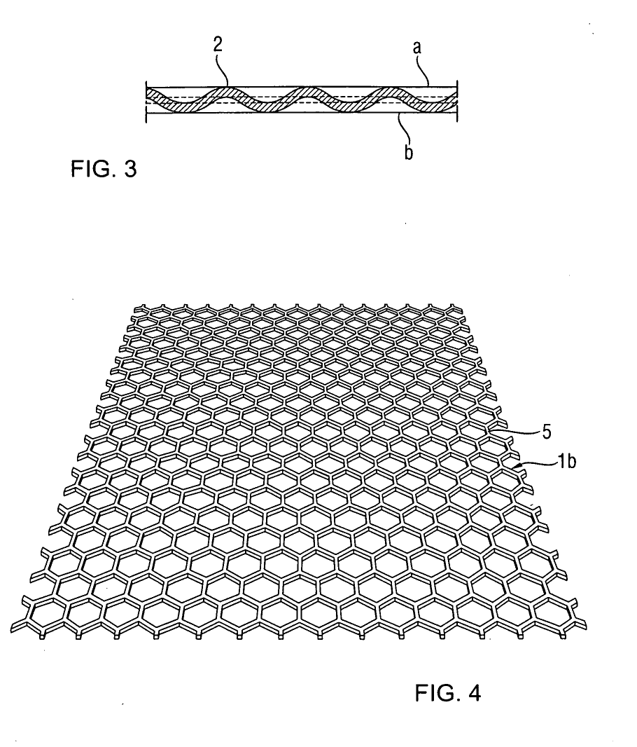

FIG. 3 shows the cross section of the metal inlay 1a used according to the invention.

FIG. 4 shows a perspective view (upper side) of a second metal inlay 1b used according to the invention, in which webs 5 are arranged in a hexagonal lattice structure. The total web area makes up about 30% of the total area of the main side.

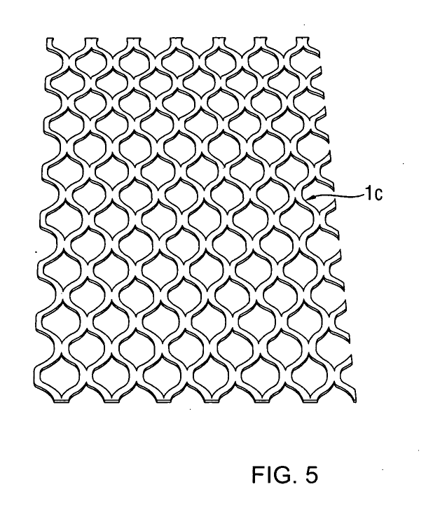

FIG. 5 shows a perspective view (upper side) of a second metal inlay 1c used according to the invention. The total web area makes up about 55% of the total area of the main side.

The functions of the metal inlay which is embedded between the applied layers is firstly to act as an internal diffusion barrier and secondly to mechanically reinforce the laminate. Metal foils or sheets made of stainless steel, steel, iron, aluminum, nickel, copper, titanium or zinc or alloys of nickel, copper, aluminum or zinc are typically used. The thickness of the metal inlays is in the range from 0.02 to 2 mm, preferably from 0.1 to 0.8 mm. The metal inlays according to the invention having a perforated structure can, for example also consist of an expanded metal lattice rolled to the starting material thickness. In this way, the holes in an expanded metal lattice are surrounded by webs which correspond substantially to the planes a and b.

The graphite used for joining to the metal is produced in a manner that is known per se, by thermal expansion of graphite intercalation compounds to form expanded graphite and subsequent compaction of the expanded graphite without addition of binder to form flexible foils or plates (U.S. Pat. No. 3,404,061; DE 26 08 866; U.S. Pat. No. 4,091,083).

For reasons of simplicity, the term “graphite” will be used in the following to refer to that product, and the cited documents are incorporated by reference.

The sealing material of the invention is preferably produced by the process described in European patent EP 0 616 884 B. The advantage of that process is that no conventional adhesives which are subject to aging, softening and/or chemical or thermal decomposition are required for producing a permanent bond between the layers. Instead, bonding agents selected from the group consisting of surface-active substances, e.g. organosilicon compounds, metal soaps or perfluorinated compounds, are used for joining the metal inlay and graphite foils. Even when applied in an extremely thin layer, i.e. only a few nm thick, to one of the metal and graphite surfaces to be joined to one another, these form a permanent bond when the coated area is brought into contact under the action of pressure and heat with the surface to which it is to be joined.

As an alternative, the sealing material of the invention can also be produced by adhesively bonding the individual layers onto one another by means of a known adhesive, provided that the use conditions of the sealing material allow this.

The impermeability of the outer layers to fluids can be improved further by impregnating these with a resin in a known manner. Suitable impregnants are, for example, furfuryl alcohol which in the presence of a curing catalyst condenses to form furan resin, phenolic resins, silicone resins, epoxy resins, and acrylic resins.

The bonding agents which can be used according to the invention are surface-active substances selected from the group consisting of organosilicon compounds, preferably silicones, perfluorinated compounds and metal soaps which are well known per se and are used as hydrophobicizing agents, antifoams or softeners in industry, e.g. in the finishing of textiles (P. Hardt, Silicon-Textilhilfsmittel, Textilveredelung 19 (1984), pp. 143-146; Ullmanns Encyklopädie der technischen Chemie, 3rd edition 1966, vol. 17, pp. 203-206). Among silicones, particular preference is given to using polysiloxanes from the group consisting of dimethylpolysiloxanes, methylhydrogenpolysiloxanes, (methylpolyalkylene oxide)dimethylpolysiloxanes, amino-modified methylpolysiloxanes, alpha,omega-dihydroxydimethylpolysiloxanes, alpha,omega-divinyldimethylpolysiloxanes, alpha,omega-dihydroxy(methylalkylamino)dimethylpolysiloxanes. From the group of surface-active, perfluorinated compounds, perfluorocarboxylic acids and perfluorinated compounds of the general formula F₃C—(CF₂)n-R where R=poly-urethane, polyacrylate, polymethacrylate and n=6-12 have been found to be particularly advantageous. None of the materials mentioned may have the character of an adhesive since otherwise the mode of action of the invention would no longer be ensured. The effect of the surface-active substances mentioned can be improved by at least one hydrolyzable salt from the group consisting of metals, aluminum, zirconium, titanium, tin, zinc, chromium being incorporated in molecular form into them either before their application to the surfaces of the metal and/or the “graphite” or after this procedure. This is effected either by mixing the appropriate components with one another in the desired ratio before application or by means of an application process to the existing applied layer after application of the first component comprising a siloxane and/or a perfluorinated compound and/or a metal soap to one or both of the surfaces to be joined. To achieve the fine dispersion necessary, use is frequently made of emulsions, dispersions or solutions. The hydrolyzable salts applied are then distributed in molecular form over the first layer by diffusion. Fatty acid salts of the metals mentioned are preferably added as hydrolyzable salts. They additionally have a crosslinking effect on the surface-active compounds and promote immobilization of these on the surfaces to which they have been applied. An epoxyamine can also advantageously be used as crosslinking aid.

The surface-active substances indicated can, depending on the class of materials to which they belong, be employed either alone or in mixtures with one another. Although mixtures of more than two of the surface-active substances are possible, they are not normal for practical reasons. Advantageous mixtures are, for example, mixtures of methylhydrogenpolysiloxane and (methylpolyalkylene oxide)dimethylpolysiloxane, mixtures of methylhydrogenpolysiloxane and alpha,omega-dihydroxydimethylpolysiloxane and mixtures of amino-modified methylpolysiloxane and alpha,omega-dihydroxydimethylpolysiloxane. A mixture of methylhydrogenpolysiloxane and dimethylpolysiloxane in an approximate weight ratio of 1:1 has been found to be particularly advantageous and is preferably processed in the form of an aqueous emulsion.

If uniform application of the surface-active substance or a mixture of such substances to the metal or “graphite” surfaces presents difficulties, the addition of a wetting agent such as an alkylsulfonate or a preparation composed of a fatty alcohol and an ether alcohol to the liquid to be applied is advisable.

The metallic component of the sealing material comprises, in particular, iron, steel, stainless steel, copper, aluminum, zinc, nickel, titanium or alloys of copper, aluminum or zinc. Which of the metals or which of the alloys is used depends on the envisaged use of the laminate. The metals and alloys can be present in the form of thin foils, sheets, plates or blocks. Before being processed to form the laminate, the metallic surfaces to be joined to the “graphite” have to be cleaned. Further surface treatments are not necessary.

The surface-active substance can be applied to one or both of the surfaces to be joined. In general, only the metallic surface of the pairing is wetted since the amount of surface-active substance used can be reduced further in this way. However, it is likewise possible to wet only the corresponding surface of the “graphite” layer.

In the application of the surface-active substances to the surfaces to be joined, it always has to be an objective to apply as little as possible of the substances but to apply this amount as uniformly as possible. For this reason, pure substances are only rarely employed in normal operation. These are generally used only when they have a sufficiently low viscosity. It is usual to employ solutions or emulsions or dispersions, with aqueous emulsions being preferred when working on a relatively large scale. Choice of appropriate degrees of dilution, possibly in combination with the addition of relatively small amounts of wetting agents, enables extremely thin layers of surface-active substances to be applied, e.g. by painting, by means of application rollers, by spraying, in each case in combination with subsequent wiping or other processes known per se. In conventional applications, the layer thickness is not more than 1000 nm. It should be not less than 10 nm. Preference is given to employing layer thicknesses of from 100 to 500 nm. It is not necessary for contiguous films of surface-active substances to be produced. A uniformly distributed dense application of very fine droplets also performs the function required according to the invention. However, wiping-off of excess liquid after the first application operation is also advisable here.

The nature of the “graphite” layer is guided by the use intended for the laminate. In general, layers having thicknesses of up to 5 mm, preferably from 0.2 to 3 mm, are used. The bulk density of the “graphite” layers to be applied is usually in the range from 0.01 to 1.8 g/cm³, preferably from 0.4 to 1.6 g/cm³. However, it is also possible to place expanded graphite (bulk density about 0.002 g/cm³) on the metallic surface which has previously been provided with a bonding agent in a suitable mold surrounding the metal inlay and then to compact this expanded graphite in this mold to form the desired “graphite” layer. Very thin “graphite” layers can be applied in this way. If appropriate, a further “graphite” layer, e.g. in the form of a foil or plate, can be pressed onto a “graphite” layer produced in the abovementioned way, so that the further layer becomes firmly joined to the underlying layer if the latter has not been compacted too much beforehand.

The “graphite” layers applied to the metal inlay before pressing can already have the bulk density which they are intended to have in the finished sealing material. In this case, the pressing pressure applied during pressing together of the layers of metal and “graphite” to produce the sealing material must not exceed the compaction pressure necessary to achieve the given bulk density of the “graphite” layer. However, it is also possible for graphite layers having a bulk density lower than the final bulk density in the finished pressed sealing material to be initially applied. The intended final bulk density is then obtained only on pressing together of the components of the sealing material.

After placing together the components forming the sealing material, the desired permanent bond between the metal and “graphite” layer(s) is produced by pressing together. The pressing together can occur continuously or discontinuously with the aid of any of the known pressing apparatuses suitable for this purpose. However, preference is given to using stamping or multiplaten presses, which should be heatable, or double belt presses.

In the formation of the permanent bond, the process parameters pressing pressure, temperature and time act in conjunction. The desired bond strength is achieved, for example when pressing is carried out at relatively low temperatures of about 30 to 50° C. for a very long time, i.e. in the order of days, under comparatively high pressures. Increasing the pressing temperature enables the pressing time required to be greatly reduced. High pressing pressures likewise shorten the pressing time. For economical operation, pressing pressures of from 1 to 50 MPa, preferably from 3 to 10 MPa, and temperatures of from 80 to 300° C., preferably from 120 to 200° C., are employed. When working within the last-named parameter range with appropriate optimization of parameters, which a person skilled in the art can easily carry out on the basis of the information given and appropriate tests, pressing times in the range from 5 minutes to 5 hours, preferably from one to two hours, are required.

The sealing materials obtained after release of the pressure and cooling to room temperature have a permanent bond between each metal layer and the “graphite” layer assigned thereto. Attempts to detach the “graphite” layer from the metal inlay, e.g. by bending or the peeling test or a pull-off test, always result in rupture within the graphite layer and not at the metal/“graphite” junction, i.e. the strength of the bond produced according to the invention between the layers of the sealing material is greater than the internal strength of the “graphite” layer(s).

Sealing materials according to the invention are resistant to handling, with the exception of mechanical damage to the comparatively soft graphite surfaces. Even in the case of thin sealing materials of this type, no delamination occurs when they are bent. The outer “graphite” layer of the sealing materials can be surface-treated, e.g. by electrochemical deposition of metals, by means of thermal processes or by impregnation with furan resin as described in DE 32 44 595, without the strength of the bond of the layers of the sealing material suffering. The bond strength is also retained in the presence of all chemical substances which do not attack the metallic part of the sealing material. When used as flat seals, sealing materials according to the invention have better leakage rates than conventional sealing materials. In addition, they are stable to delamination of the “graphite” part.

### Example 1

The leakage rate of a sealing material having the structure shown in table 1 was tested in accordance with the VDI Guideline 2440.

TABLE 1

| Layer | Material | Thickness/mm | Density/g/cm³ |
|---|---|---|---|
| Outer layers | Graphite foil | 0.8 | 1.0 |
| Metal inlay | Stainless steel 316 (L) | 0.5 | |

For the measurement, the seal was clamped between DIN flanges DN40 PN40 having a flat sealing surface. The roughness of the sealing surfaces was Ra≦6.3 μm. The screws were tightened using a force which led to a pressure of 30 MPa. After assembly, the clamped flange packet was stored at 300° C. in an oven for 48 hours. After cooling, the absolute leakage rate was measured by means of a helium leak detector (mass spectrometer) at a differential helium pressure of 1 bar.

The average circumference of the actually pressed sealing area was employed to determine the specific leakage rate.

The sealing material according to the invention gives a leakage rate which is significantly below the limit of 1*10⁻⁵ kPa*l(/s*m) (as prescribed by TA Luft).

### Example 2

Two graphite foils having a thickness of 1.0 mm are pressed onto a perforated steel sheet having a hexagonal lattice structure at 5 MPa in a press. The thickness of the metal sheet is 1.5 mm, with the web lengths being about 3.6 mm and the web widths being about 0.8 mm. Stamping out to give the seal geometry displays sufficient adhesion between the layers.

### Comparative Example

Using a method analogous to Example 2, a laminate is produced by pressing a commercial expanded metal between two graphite foils as described in Example 2.

The specimens obtained as described in the above examples were subjected to a leakage measurement using a method based on DIN EN 13555.

A comparison of the values determined is shown in the following table 2.

TABLE 2

| | |
|---|---|
| Clamping pressure | Helium leakage rate in mg/(s * m) |

| in MPa | Example 2 | Comparative example |
|---|---|---|
| 10 | 1.1E−01 | 1.6 |
| 20 | 7.0E−03 | 1.5E−01 |
| 40 | 2.7E−04 | 1.8E−02 |
| 60 | 2.5E−05 | 3.0E−03 |
| 80 | 4.3E−06 | 3.8E−04 |
| 100 | 9.2E−07 | 6.2E−05 |
| 120 | 1.4E−07 | 1.5E−06 |

### Example 3

The leakage rate of a sealing material having the structure shown in table 3 was tested in accordance with the VDI Guideline 2440.

TABLE 3

| Layer | Material | Thickness [mm] | |
|---|---|---|---|
| Outer layers | Graphite foil | 0.8 | 1.0 g/cm³ |
| Metal inlay | Stainless | 0.7 | 56% free hole area |
| | steel 1.4401 | | |

For the measurement, the seal was clamped between DIN flanges DN40 PN40 having a flat sealing surface. The roughness of the sealing surfaces was Ra≦6.3 μm. The screws were tightened using a force which led to a pressure of 30 MPa. After assembly, the clamped flange packet was stored at 300° C. in an oven for 48 hours. After cooling, the absolute leakage rate was measured by means of a helium leak detector (mass spectrometer) at a differential helium pressure of 1 bar.

The average circumference of the actually pressed sealing area was employed to determine the specific leakage rate.

The sealing material according to the invention gives a leakage rate which is significantly below the limit of 1*10⁻⁵ kPa*l(/s*m) (as prescribed by TA Luft).

1. A sealing material, comprising:
a sheet-like laminate composed of at least two layers of a graphite foil having a density of not more than 1.6 g/cm³ alternating with at least one metal inlay, said laminate having two main sides;
said metal inlay having a three-dimensional structuring and one-sided open depressions covered by graphite layers having a thickness in a range up to 5.0 mm;
said depressions being enclosed by linearly intersecting raised regions defining ridge lines on said two main sides lying approximately on defined planes a and b.

2. The sealing material according to claim 1, wherein said metal inlay comprises two structured metal sheets having linearly intersecting raised regions on only one main side with ridge lines lying approximately on a plane and being joined to one another by the respectively other said main side, and wherein said ridge lines and depressions in each case are disposed opposite one another on a rear side thereof.

3. The sealing material according to claim 1, wherein said ridge lines are formed with a spacing in a range from 1.0 mm to 8.0 mm and a height of said linear raised regions lies in a range from 0.2 mm to 3.0 mm.

4. The sealing material according to claim 3, wherein said spacing between said ridge lines is in the range from 2.0 mm to 4.0 mm and the height of said linear raised regions lies in the range from 0.5 mm to 1.5 mm.

5. The sealing material according to claim 1, wherein the density of said graphite foil is from 0.40 to 1.60 g/cm³.

6. The sealing material according to claim 1, wherein said metal inlay embedded between said graphite layers has a thickness of from 20 μm to 2.0 mm.

7. The sealing material according to claim 6, wherein said metal inlay has a thickness of from 0.1 mm to 0.8 mm.

8. The sealing material according to claim 1, wherein said metal inlays embedded between the graphite layers comprise materials selected from the group consisting of stainless steel, steel, iron, aluminum, nickel, copper, titanium, and zinc, and alloys of nickel, copper, aluminum, or zinc.

9. The sealing material according to claim 1, wherein said metal inlays are joined to said graphite foils by way of a surface-active bonding agent selected from the group consisting of organosilicon compounds, metal soaps, and perfluorinated compounds, or by way of an adhesive.

10. The sealing material according to claim 1, wherein said outer layers of graphite foil contain an impregnation of furan resin, phenolic resin, epoxy resin, silicone resin, acrylic resin, or mixtures thereof.

11. The sealing material according to claim 1, wherein a leakage rate of a seal formed by said sealing material, measured in accordance with VDI Guideline 2440, is less than or equal to 10⁻⁵ kPa*1/(s*m).

12. A sealing material, comprising:
a sheet-like laminate composed of at least two layers of a graphite foil having a density of not more than 1.6 g/cm³ alternating with at least one metal inlay, said laminate having two main sides;
said metal inlay having a perforated structure covered on both sides by graphite layers having a thickness of up to 5.0 mm and having holes enclosed by webs, and wherein said webs on said two main sides lie approximately on defined planes a and b and an area of the holes making up from 40% to 90% of a total area of said metal inlay.

13. The sealing material according to claim 12, wherein said area of said holes makes up from 50 to 80% of said total area of said metal inlay.

14. The sealing material according to claim 12, wherein the density of said graphite foil is from 0.40 to 1.60 g/cm³.

15. The sealing material according to claim 12, wherein said metal inlay embedded between said graphite layers has a thickness of from 20 μm to 2.0 mm.

16. The sealing material according to claim 15, wherein said metal inlay has a thickness of from 0.1 mm to 0.8 mm.

17. The sealing material according to claim 12, wherein said metal inlays embedded between the graphite layers comprise materials selected from the group consisting of stainless steel, steel, iron, aluminum, nickel, copper, titanium, and zinc, and alloys of nickel, copper, aluminum, or zinc.

18. The sealing material according to claim 12, wherein said metal inlays are joined to said graphite foils by way of a surface-active bonding agent selected from the group consisting of organosilicon compounds, metal soaps, and perfluorinated compounds, or by way of an adhesive.

19. The sealing material according to claim 12, wherein said outer layers of graphite foil contain an impregnation of furan resin, phenolic resin, epoxy resin, silicone resin, acrylic resin, or mixtures thereof.

20. The sealing material according to claim 12, wherein a leakage rate of a seal formed by said sealing material, measured in accordance with VDI Guideline 2440, is less than or equal to 10⁻⁵ kPa*1/(s*m).
